(19) United States
(12) Patent Application Publication
(10) Pub. No.: US 2026/0331029 A1
(43) Pub. Date: Oct. 22, 2026

(54) DISPLAY DEVICE AND TIMING CONTROLLER

(71) Applicant: LG ELECTRONICS INC., Seoul (KR)

(72) Inventor: Yongsu YOO, Seoul (KR)

(73) Assignee: LG ELECTRONICS INC., Seoul (KR)

(21) Appl. No.: 19/115,007

(22) PCT Filed: Nov. 3, 2022
(86) PCT No.: PCT/KR2022/017108

§ 371 Date: Mar. 25, 2025

(51) Int. Cl. G09G 3/32; G09G 3/3266; G09G 3/3275; G09G 3/36

(52) U.S. Cl. CPC G09G 3/32; G09G 3/3266; G09G 3/3275; G09G 3/3677; G09G 3/3688; G09G 2310/0267; G09G 2310/0275; G09G 2310/08; G09G 2340/0435

(57) ABSTRACT

A display device according to an embodiment of the present disclosure comprises: a gate driving circuit which selects at least one gate line of a display panel; a source driving circuit which converts video data corresponding to the selected gate line into a video signal and outputs the video signal to a source line of the display panel; and a timing controller which determines an operation sequence of the at least one gate line.

### TECHNICAL FIELD

The present disclosure relates to a display device (e.g., a TV, a monitor, a mobile phone, a tablet PC, a pad, and the like) and a timing controller (T-Con), and is particularly applicable to all devices for minimizing a delay of a video such as game content.

### BACKGROUND

Recently, as a magnitude of a computer game industry has grown, competition between computer game companies has become fiercer, and competition between gamers has also become fiercer. Because of the fierce competition between the computer game companies, a level of computer game production has increased, and because of the fierce competition between the gamers, a level of game competition has also increased. Such improvement in the level of game-related fields has led to computer games being socially recognized as a type of sport under a name of e-sports.

In such a situation, just as sports equipment such as sportswear and shoes affect a performance of athletes in sports, even small differences in specifications of gaming devices in the computer games may affect gamer's victory or defeat in the game.

A “video latency” of the gaming device may be an example of such specifications. A short “video latency” is considered important when a gamer's fast response speed to a change in a game video determines the victory or the defeat in the game.

For example, in a car racing game, when I recognize a moment when light changes from red to blue before my opponent, I may start my car earlier than my opponent, which will give me an advantage in winning the game. In a gunfight competition game, when I find my opponent before my opponent finds me, I may pull a trigger before my opponent, which will give me an advantage in the gunfight competition computer game.

In a game that uses a mouse pointer, when my mouse pointer reaches a location I commanded faster than my opponent's mouse pointer, I will have an advantage in winning the game. To this end, a video latency of my gaming device should be shorter than a video latency of my opponent's gaming device.

For this reason, the professional gamers consider the video latency of the gaming device an important specification. Fans of the professional gamers or ordinary people exposed to this aspect are also greatly influenced by opinions of the professional gamers during their product purchasing process. Further, even when a difference in the video latency between the gaming devices is too small compared to human perception and reaction ability to actually affect the game, as competition among gaming device manufacturers intensifies, the video latency is becoming a symbolic factor representing a performance of the gaming device regardless of the actual effect thereof, and is becoming an important marketing point for the gaming device. There is even a website on the Internet that ranks display devices with excellent “input lag”, a specification related to the video latency.

### SUMMARY

### Technical Problem

A video latency of a game is determined by complex influence between a game system, which is composed of a game SW, a CPU of a gaming device, and a graphic engine of the gaming device, and a display device, such as a monitor and a TV.

The display device is divided into a display system that treats and processes video data and a display panel that actually displays a video.

The present disclosure focuses on the display panel to solve the problems of the prior art.

In the case of the game system, it has been developed to meet a requirement of the game, which is a short video latency, with a high video frame rate or a vertical synchronization technology, and in the case of the display system, it has achieved a technical extreme level of video latency of almost 1 video frame by supporting a function called “game mode” that minimizes a video processing delay time to respond to such recent demand of the game. On the other hand, there has been no technical attempt to reduce the video processing delay time in the display panel and thus the present disclosure aims to solve such problems.

### Technical Solutions

A display device according to an embodiment of the present disclosure includes a gate driving circuit that selects at least one gate line of a display panel, a source driving circuit that converts video data corresponding to the selected gate line into a video signal, and outputs the video signal to a source line of the display panel, and a timing controller that determines an operation order of the at least one gate line. Particularly, the timing controller changes the operation order of the at least one gate line based on region of interest (ROI) information received from a game system.

Further, the timing controller may, when the reception of the ROI information from the game system fails, change the operation order of the at least one gate line based on location information of a mouse pointer.

Further, the timing controller may, when the display device corresponds to a TV and operates in a specific mode, control the at least one gate line to operate starting from a center of the display panel.

The specific mode may, for example, correspond to a game mode where both upper and lower regions of the display panel are processed in black.

The game system may, for example, be located inside or outside the display device.

Further, the game system may include both a memory for a reading mode and a memory for a writing mode.

Video data stored in the memory for the reading mode may be read in a specific direction and in a specific order based on ROI information, whereas video data may be written in fixed direction and order regardless of ROI information in the memory for the writing mode.

For example, when a maximum resolution of the display panel is 8K, at least 13 bits may be used to control the gate driving circuit.

A timing controller according to an embodiment of the present disclosure receives region of interest (ROI) information from a game system, and changes an operation order of at least one gate line based on the received ROI information.

### Advantageous Effects

According to an embodiment of the present disclosure, to solve the above-mentioned problems of the prior art, proposed is a method in which, among the video data of the one video frame, the location of the important object (region of interest, ROI) on the screen is determined, and then the order of updating the horizontal lines of the display panel and the order of reading and writing of the display output memory within the game system are optimized, so that the ROI with the change in the motion is given the high priority and is updated earlier than the relatively less important video data.

Additional scope of the applicability of the present disclosure will become apparent from a detailed description below.

However, because various changes and modifications within the spirit and scope of the present disclosure may be clearly understood by those skilled in the art, it should be understood that the detailed description and specific embodiments such as preferred embodiments of the present disclosure are given only as examples.

### BRIEF DESCRIPTION OF THE DRAWINGS

FIG. 1 illustrates a specific structure of a display panel according to an embodiment of the present disclosure.

FIG. 2 is a diagram for illustrating a difference in a video update time point based on a display panel location.

FIG. 3 is a diagram for illustrating a difference in a video update time point during execution of a first game.

FIG. 4 is a diagram for illustrating a difference in a video update time point during execution of a second game.

FIG. 5 is a diagram for illustrating a difference in a video update time point during execution of a third game.

FIG. 6 is a diagram for illustrating an optimal operation direction of a gate driving circuit based on a ROI location according to an embodiment of the present disclosure.

FIG. 7 is a diagram for illustrating an optimal operation direction of a gate driving circuit when an ROI location is a center of a screen according to an embodiment of the present disclosure.

FIG. 8 is a diagram for illustrating an optimal operation direction of a gate driving circuit when an ROI search fails according to an embodiment of the present disclosure.

FIG. 9 is a diagram for illustrating an optimal operation direction of a gate driving circuit when a TV operates in a first specific mode according to an embodiment of the present disclosure.

FIG. 10 is a diagram for illustrating an optimal operation direction of a gate driving circuit when a TV operates in a second specific mode according to an embodiment of the present disclosure.

FIG. 11 is a diagram for illustrating a method for detecting an ROI in one video according to an embodiment of the present disclosure.

FIG. 12 is a diagram for illustrating a process for changing an order of video data in a game system that separately has a memory for a reading mode and a memory for a writing mode according to an embodiment of the present disclosure.

FIG. 13 is a diagram for illustrating a process for changing an order of video data in a game system implemented with one memory for a reading mode and a writing mode according to the embodiment of the present disclosure.

FIG. 14 illustrates a bidirectional shift register according to an embodiment of the present disclosure.

Further, FIG. 15 is a diagram for illustrating the minimum number of bits for controlling a gate driving circuit according to an embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

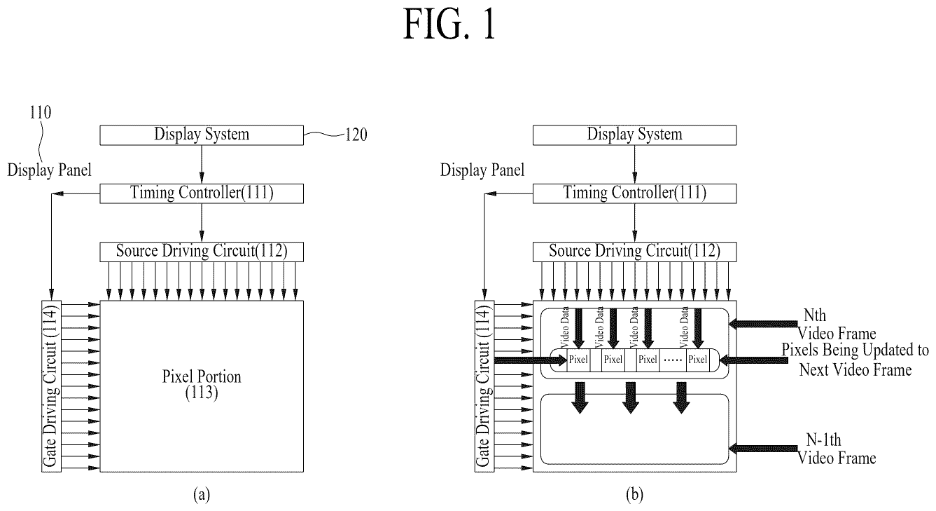

FIG. 1 illustrates a specific structure of a display panel according to an embodiment of the present disclosure.
(a) in FIG. 1 illustrates the structure of the display panel. A display panel 110 illustrated in (a) in FIG. 1 refers to, for example, an LED, a mini LED, a micro LED, an OLED, an LCD, or a PDP.

As illustrated in (a) in FIG. 1, a pixel portion 113 is positioned at a center of the display panel 110, a source driving circuit 112 is positioned above the pixel portion 113, and a gate driving circuit 114 is positioned next to the pixel portion 113.

Furthermore, the source driving circuit 112 and the gate driving circuit 114 are controlled by a timing controller 111.

The timing controller 111 is controlled by a display system 120 located outside the display panel 110.
(b) in FIG. 1 illustrates a principle of updating one video on the display panel. The gate driving circuit turns on pixels located on one horizontal line of the display panel. This “turning on” operation starts from an uppermost end of the display panel and sequentially occurs in a downward direction based on the display panel.

The source driving circuit transmits appropriate video data to the turned-on pixels. The pixels receive and store this video data and render colors of brightness corresponding to this video data. The pixels located on one horizontal line of the display panel are updated in this principle, and when the pixels located on all horizontal lines constituting the one video are completely updated in such manner, an update operation of the one video is finally completed.

That is, the update of one video frame on the display panel is not performed in an instant, but is performed sequentially one horizontal line at a time.

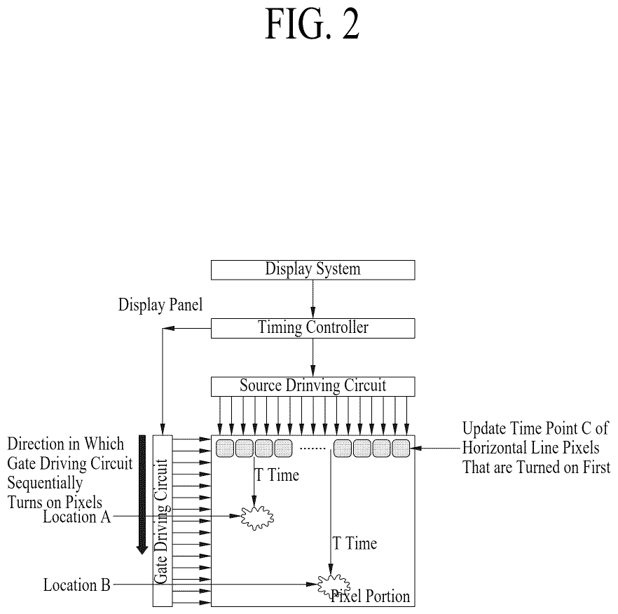

FIG. 2 is a diagram for illustrating a difference in a video update time point based on a display panel location.

First, as shown in FIG. 2, a description will be made by comparing video update time points at a location A corresponding to the upper end of the display panel and a location B corresponding to a lower end of the display panel with each other.

It is assumed that, starting with pixels located at an uppermost horizontal line of the display panel, the video is updated sequentially one horizontal line at a time in a direction toward the lower end of the display panel.

In this regard, in the case of location A, the video is updated after T time based on C, which is a video update time point of pixels on a first horizontal line of the display panel.

On the other hand, in the case of location B, the video is updated after T′ time based on C, which is the video update time point of the pixels on the first horizontal line of the display panel.

That is, the T′ time is greater than the T time, and therefore, the farther the pixels are located downward in a vertical direction from the location of the pixels on the horizontal line that the gate driving circuit first turns on for the video frame update, the later the video update is performed.

As mentioned above, the time at which the video is updated varies depending on the location of the pixels on the display panel. Problems caused by such an operating characteristic will be described below.

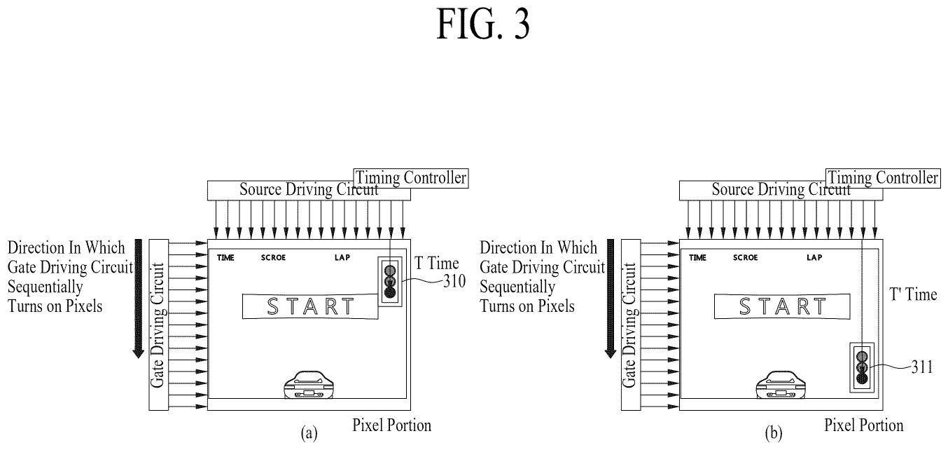

FIG. 3 is a diagram for illustrating a difference in a video update time point during execution of a first game.

FIG. 3 illustrates an example of a game related to car racing. When a traffic light changes from red to blue at a starting line of the car race, a gamer starts a car.

For the gamer to start the car as early as possible, it will be important to recognize the change of the traffic light from red to blue as early as possible.
(a) in FIG. 3 illustrates a case in which a traffic light 310 whose color changes is placed at an upper end of a screen, and (b) in FIG. 3 illustrates a case in which a traffic light 311 whose color changes is placed at a lower end of the screen.

Therefore, in the case of (a) in FIG. 3, it takes T time for pixels related to the traffic light 310 to turn on, while in the case of (b) in FIG. 3, it takes T time for pixels related to the traffic light 311 to turn on. That is, there is a problem that light of the traffic light located at the lower end of the screen is updated relatively later than light of the traffic light located at the upper end of the screen. This problem occurs because, according to the prior art, the gate driving circuit operates only in the initially set downward direction.

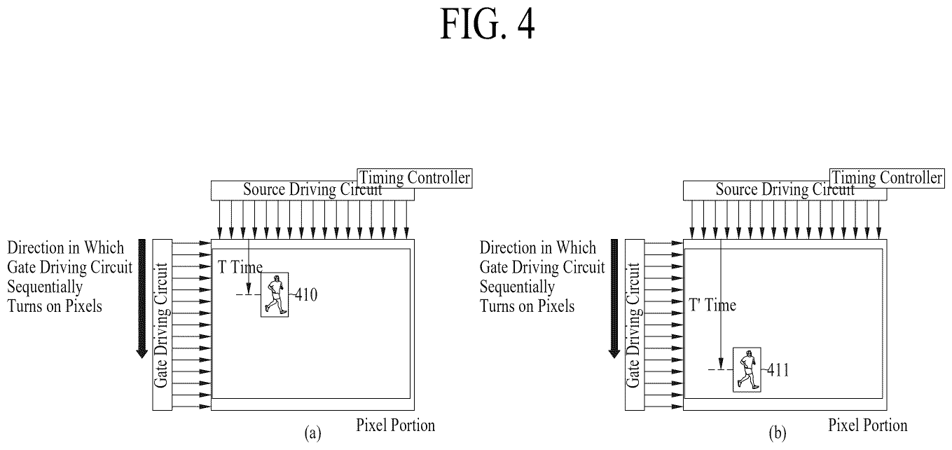

FIG. 4 is a diagram for illustrating a difference in a video update time point during execution of a second game.

FIG. 4 illustrates an example of a game related to a gunfight. In such a game, it is very important for the gamers to discover an opponent before they are discovered by the opponent. This is because only then may they pull a trigger at an earlier time than the opponent.
(a) in FIG. 4 illustrates an example in which an opponent or enemy 410 holding a gun is positioned at the upper end of the screen, and (b) in FIG. 4 illustrates an example in which an opponent or enemy 411 holding a gun is positioned at the lower end of the screen.

Therefore, in the case of (a) in FIG. 4, it takes T time for pixels related to the opponent or enemy 410 to turn on, while in the case of (b) in FIG. 4, it takes T′ time for pixels related to the opponent or enemy 411 to turn on. In other words, there is a problem that the opponent/enemy located at the lower end of the screen is updated relatively later than the opponent/enemy located at the upper end of the screen. This problem occurs because, according to the prior art, the gate driving circuit operates only in the initially set downward direction.

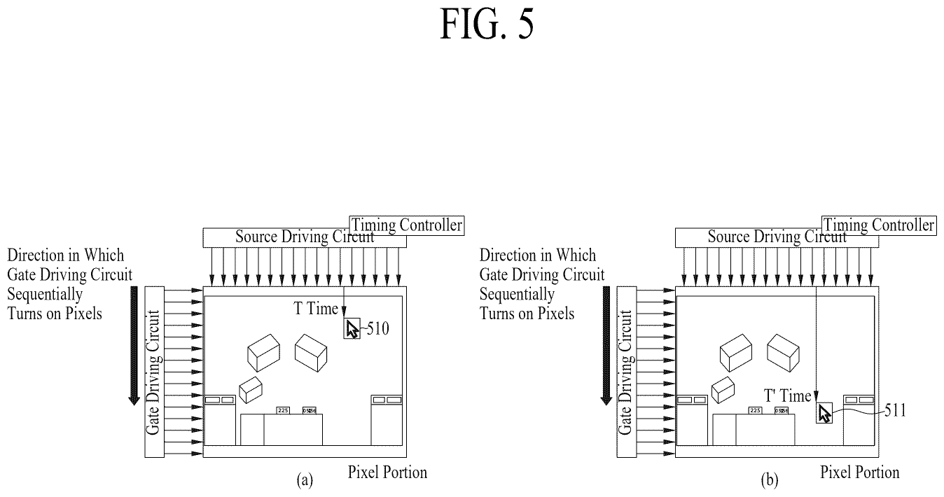

FIG. 5 is a diagram for illustrating a difference in a video update time point during execution of a third game.

Among various types of games, there are certain types of games that use a mouse pointer. It is advantageous for the gamer when the mouse pointer quickly arrives at a location commanded by the gamer or a UI quickly changes to reflect a click of the mouse pointer when the gamer presses a mouse click button.
(a) in FIG. 5 assumes that a target location where the mouse pointer moves to in the game or a location 510 where the mouse click occurred is the upper end of the display panel, while (b) in FIG. 5 assumes that a corresponding location 511 is the lower end of the display panel.

In this case, in (a) in FIG. 5, it takes T time for the mouse pointer to be perfectly displayed, while in (b) in FIG. 5, it takes T′ time for the mouse pointer to be perfectly displayed. There is a problem that the mouse pointer movement at the lower end of the screen is updated relatively later than the mouse pointer movement at the upper end of the screen. This problem occurs because, according to the prior art, the gate driving circuit operates only in the initially set downward direction.

In the present disclosure, to solve the aforementioned problems, it is designed that, a location of a region of interest (ROI) on the screen is determined in the video of one video frame, and then an order of updating the horizontal lines of the display panel and an order of reading and writing of a display output memory within a game system are optimized to give priority to the important ROI and to allow the ROI to be updated more quickly than a relatively less important video region. Hereinafter, various related embodiments will be described in more detail.

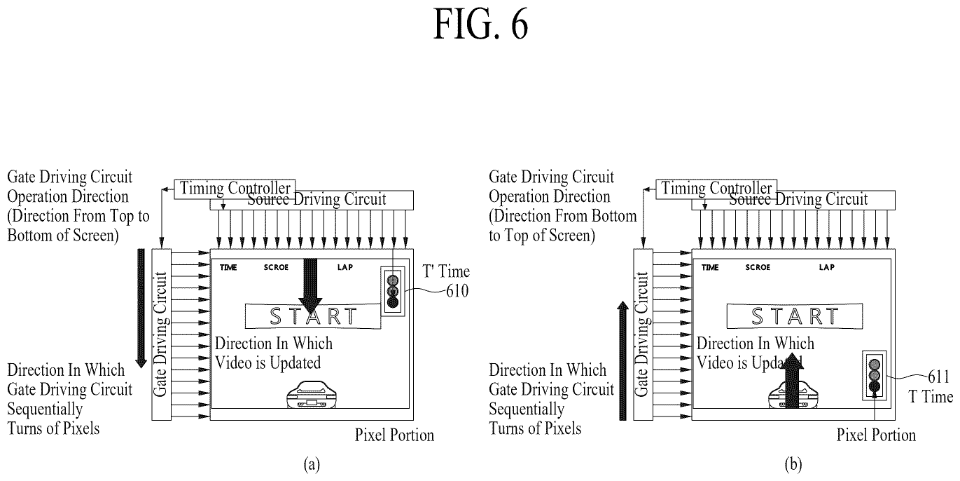

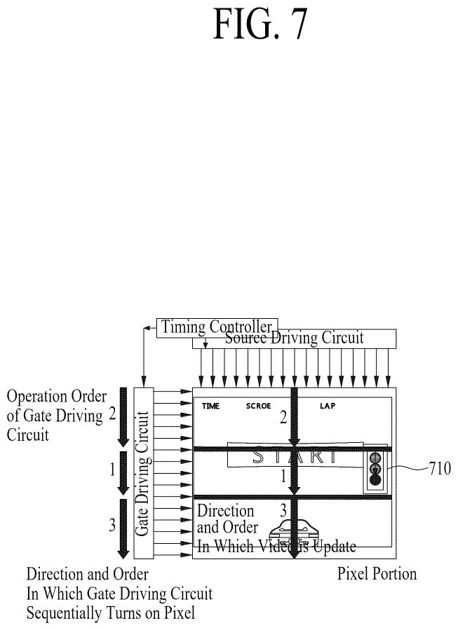

FIG. 6 is a diagram for illustrating an optimal operation direction of a gate driving circuit based on a ROI location according to an embodiment of the present disclosure. FIG. 7 is a diagram for illustrating an optimal operation direction of a gate driving circuit when an ROI location is a center of a screen according to an embodiment of the present disclosure.

FIGS. 6 and 7 both illustrate the starting line of the car racing game as an example. The most important ROI in the current video is a location of a traffic light.

In the case of (a) in FIG. 6, a traffic light 610 is located at the upper end of the screen. In this case, the operation direction of the gate driving circuit of the display panel is sufficiently set to a direction in which the upper end of the display panel is updated early, with the upper end of the display panel as a starting point and a lower end of the display panel as an ending point. Such design has a technical effect that the traffic light 610, which is an ROI located at the upper end of the display panel screen, is updated early.

On the other hand, in the case of (b) in FIG. 6, a case in which a traffic light 611, which is an ROI, is located at the lower end of the screen is illustrated. By the same principle, the gate driving circuit of the display panel may be designed to start operating from the lower end of the display panel and operate upward, which is a direction of updating the lower end of the display panel as early as possible. Such design has a technical effect that the ROI located at the lower end of the display panel is updated first.

That is, as shown in FIG. 6, the display device according to an embodiment of the present disclosure includes the gate driving circuit, the source driving circuit, the timing controller, and the like.

The gate driving circuit selects at least one gate line of the display panel.

The source driving circuit converts video data corresponding to the selected gate line into a video signal and outputs the video signal to a source line of the display panel.

Further, the timing controller determines an operation order of the at least one gate line.

In particular, as described above, unlike the prior art, the timing controller is designed to change the operation order of the at least one gate line in real time or for each frame based on region of interest (ROI) information (e.g., video data corresponding to the traffic light in the racing game) received from the game system. In one example, it is also within the scope of other rights of the present disclosure to design the timing controller to receive an operation order corresponding to the ROI information without directly receiving the ROI information.

However, when the timing controller fails to receive the ROI information from the game system or the like or the ROI information itself does not exist, the timing controller is designed to automatically change the operation order of the gate line based on location information of the mouse pointer.

Further, FIG. 7 illustrates a case in which a traffic light 710, which is an ROI, is located at a central region of the video. The fastest way to update the traffic light 710 is to first update the central region of the display panel, which is a region where the traffic light belongs, and then update remaining regions.

To implement this, the gate driving circuit is designed to operate some of horizontal lines located at the central portion of the display panel first and then operate horizontal lines of the remaining portions of the display panel thereafter.

Such design has a technical effect that the central portion of the display panel is updated with the highest priority and the ROI located at the center of the screen is also updated early.

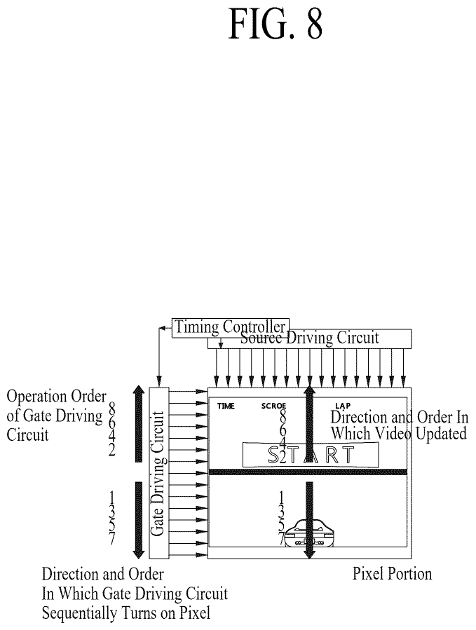

FIG. 8 is a diagram for illustrating an optimal operation direction of a gate driving circuit when an ROI search fails according to an embodiment of the present disclosure.

FIG. 8 is an embodiment for cases in which it is difficult to determine the ROI in one video and thus the priority of the operation order is not able to be determined, in which a video that does not need to be given the priority of the operation order because there is no overwhelming ROI is displayed on the screen, or in which the ROI search fails.

Users who play the games often stare at the center of the screen, and statistically, main events of the games often occur at the center of the video, so that the center of the screen is more likely to be important than a periphery of the screen.

Therefore, considering this point, starting from the central portion of the display panel, the gate driving circuit sequentially updates the horizontal lines in downward and upward directions of the display panel.

Such design has technical effects that the closer the region is to the center of the display panel, the earlier the video data is updated, increasing a probability that the ROI where important objects are located is updated more quickly.

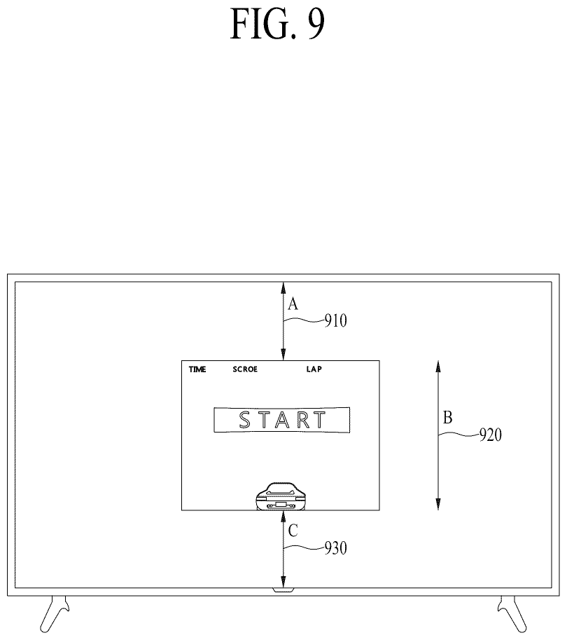

FIG. 9 is a diagram for illustrating an optimal operation direction of a gate driving circuit when a TV operates in a first specific mode according to an embodiment of the present disclosure.

Recently, the number of users using the TV as a game monitor is increasing, and TV manufacturers are also tending to add game optimization functions to the TVs to respond to such demands. One example of such functions is a “game screen size” function.

The “game screen size” function will be described as follows. For example, when a TV screen is too large to be used for gaming, it may cause inconvenience in gaming. The “game screen size” function refers to a function that intentionally reduces a size of a region on the TV screen where the game is displayed to solve this problem.

FIG. 9 illustrates a case in which the TV executes the “game screen size” function as an example. A black image is continuously displayed in a region A 910, which is an upper end of the TV screen, and a region C 930, which is a lower end of the TV screen. There is a problem that, although these regions are unimportant regions, video data (black image) of the region A 910 is updated first, and a region B 920, which is the most important region, is updated thereafter.

That is, according to the prior art, there is a problem that a time point at which video data of the region B 920, which is the most important region, is updated is always delayed by “1 video frame time*A/(A+B+C)”.

On the other hand, when the method proposed by the present disclosure is applied, the video data of the region B 920 is always updated before the video data of the region A 910, so that there is a technical effect of fundamentally eliminating the aforementioned delay problem.

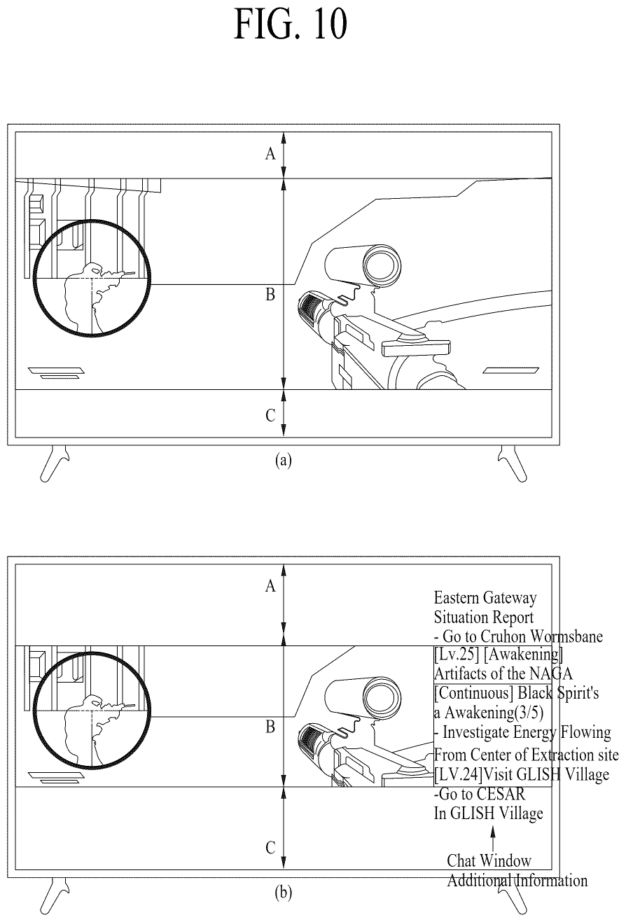

FIG. 10 is a diagram for illustrating an optimal operation direction of a gate driving circuit when a TV operates in a second specific mode according to an embodiment of the present disclosure.

There is a mode that intentionally increases a vertical-to-horizontal ratio of the video to increase immersion or realism of the game or to show more game-related additional information on the screen.

This mode is also called “wide aspect ratio”. In this mode, extended display identification data (EDID) of a display device, which is a video sink device, is changed, so that a video source device transmits a signal in a form of the “wide aspect ratio” to the video sink device.

As described above in FIG. 9, there are black regions (e.g., letter boxes) at the upper and lower ends of the screen in FIG. 10. Although these regions are not unimportant regions, according to the prior art that updates video data (black image) of a region A first, there is a problem that an update time point of video data of a region B, which is an important region, is always delayed by “1 video frame time*A/(A+B+C)”.

On the other hand, when the method proposed by the present disclosure is applied, the video data of the region B is always updated before the video data of the region A, so that there is a technical effect of fundamentally eliminating the aforementioned delay problem.

That is, as described above in FIGS. 9 and 10, when the TV operates in the specific mode, the timing controller according to an embodiment of the present disclosure controls the at least one gate line to operate from the center of the display panel.

Here, the specific mode described above includes, for example, a game mode in which both upper and lower regions of the display panel are processed in black, as illustrated in FIGS. 9 and 10.

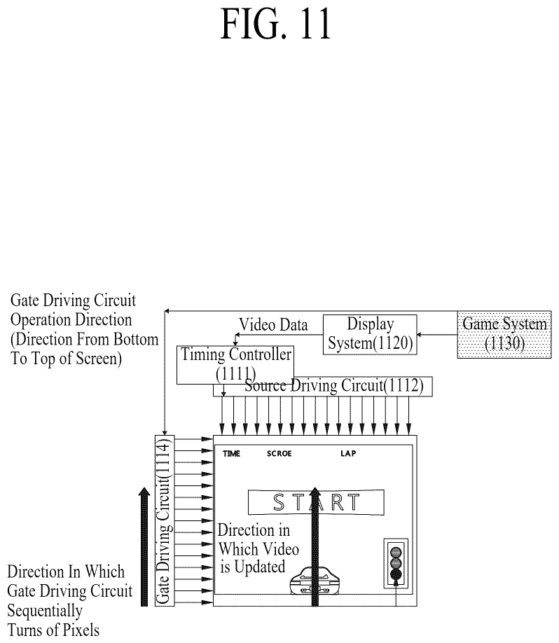

FIG. 11 is a diagram for illustrating a method for detecting an ROI in one video according to an embodiment of the present disclosure. Referring to FIG. 11, a process of determining the ROI in one video will be described.

FIG. 11 illustrates an example of a car racing game, and a game system 1130 already recognizes that the most important ROI in a current screen is a traffic light. In FIG. 11, the traffic light, which is the ROI, is located at the lower end of the screen. Because the game system 1130 has placed the traffic light at the lower end of the screen, the game system 1130 recognizes both existence and location of the ROI.

Because the game system 1130 already knows that the current ROI is the traffic light and that the location thereof is the lower end of the video, the game system 1130 changes an operation direction of a gate driving circuit 1114 that may update the lower end of the video most quickly.

More specifically, for example, the game system 1130 is designed to transmit video data to a source driving circuit 1112 via a display system 1120.

Then, the game system 1130 transmits information on the operation direction of the gate driving circuit to the gate driving circuit 1114 in the display panel, directly or via a timing controller 1111.

In one example, in a case of the game using the mouse pointer, the mouse pointer becomes the ROI. A location of the mouse pointer may also be recognized by the game system 1130 or the display device.

As described above, even when the operation order of the gate driving circuit of the display panel is changed, for the display panel to display the video normally, an order of the video data supplied to the display panel should be appropriately changed to match the changed operation order of the gate driving circuit.

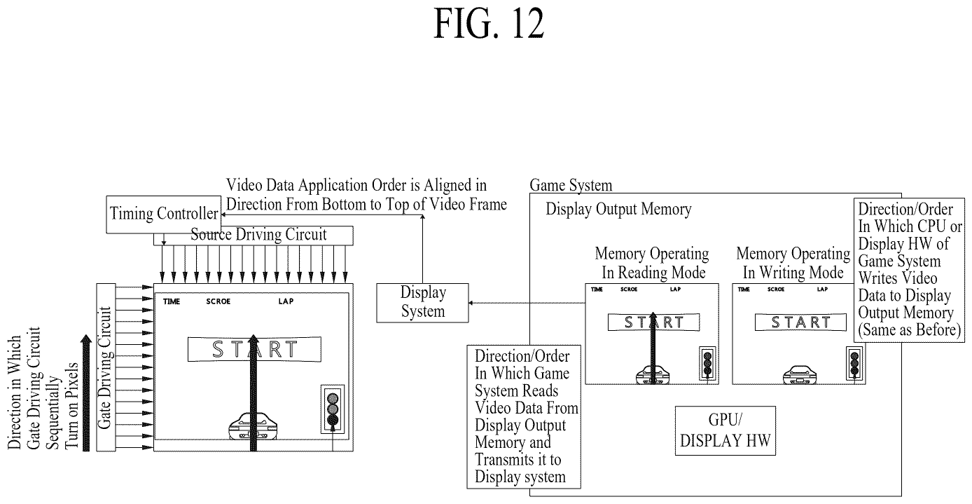

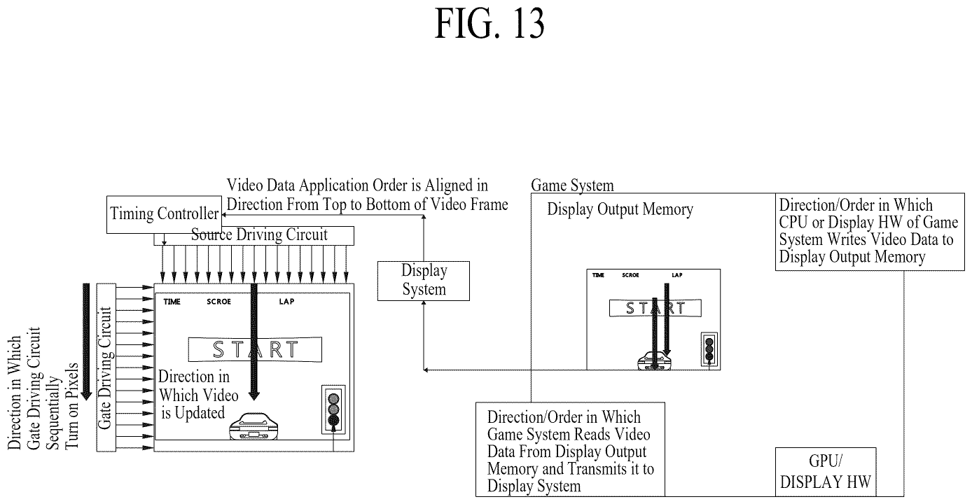

The video data supplied to the display panel/display system is generated by the game system and stored inside the display output memory within the game system. The display output memory is categorized into a type of being divided into two for a reading mode and a writing mode and a type that uses only one memory and in which reading and writing occur simultaneously in one memory. For the respective situations, solutions for arranging video data in the order required by the present disclosure will be described below with reference to FIGS. 12 and 13, respectively.

FIG. 12 is a diagram for illustrating a process for changing an order of video data in a game system that separately has a memory for a reading mode and a memory for a writing mode according to an embodiment of the present disclosure.

FIG. 12 illustrates a structure in which the display output memory used when the game system transmits the video data to the display system is separated into the memory for the reading mode and the memory for the writing mode.

Using a double buffer, i.e., a back buffer and a front buffer, a next screen to be output is inserted into the back buffer. By switching the front buffer and the back buffer when the screen is updated, the video of the back buffer is continuously displayed. This enables natural screen transition.

Video data to be displayed at a next video frame time is written in a writing memory area, and at the same time, data is read in a reading memory area. This data is video data displayed at a current video frame time. In this regard, the read video data is transmitted to the display panel via the display system. Furthermore, a frame rate of the video is determined based on the number of times such a reading operation occurs within one second.

When the reading operation is completed, in terms of roles, the reading memory area changes to the writing memory area, while the writing memory area changes to the reading memory area.

According to the prior art, in reading the video data in the reading memory area of the display output memory, a direction and an order of the reading are fixed. On the other hand, in the present disclosure, the fixed reading direction and order of the memory are dynamically changed, so that the video data supplied to the display panel are designed to be arranged in the order required by the present disclosure. However, the writing operation may be the same as that in the existing method.

Referring to FIG. 12, a method of arranging the video data in the order required by the present disclosure when the ROI is located at the lower end of the video will be described.

The gate driving circuit is operated in a direction from the lower end to the upper end of the display panel, which is a direction that updates the lower end of the display panel at the earliest possible time.

An order of application of the video data required by the display panel, according to such operation direction of the gate driving circuit, follows the direction from the lower end to the upper end of the display panel. The operation of reading the video data in the reading memory area of the display output memory is performed in the direction from the lower end to the upper end of the screen. The read video data is transmitted to the display system and the display panel, and this is the video data arranged in the order required by the display panel.

In one example, in the game system, when a GPU/display HW writes the video data in the writing area of the display output memory, the video data may be written in the same way as in the existing method.

For reference, the game system illustrated in FIG. 12 may be located, for example, inside or outside the display device.

Further, as described above, the video data stored in the memory for the reading mode included in the game system is designed to be read in the specific direction and the specific order based on the ROI information, whereas the video data in the memory for the writing mode is designed to be written in the fixed direction and order regardless of the ROI information.

FIG. 13 is a diagram for illustrating a process for changing an order of video data in a game system implemented with one memory for a reading mode and a writing mode according to the embodiment of the present disclosure.

FIG. 13 illustrates a structure in which one display output memory is used when the game system transmits the video data to the display system, and the reading and the writing occur simultaneously in this one memory.

The reading operation is a process in which the video data stored in the display output memory is read and transmitted to the display system and the display panel. The frame rate of the video is determined based on the number of times such a reading operation occurs within one second.

According to the prior art, the direction and the order in which the video data is read in the display output memory are fixed, but in the present disclosure, the reading direction and order of the memory are dynamically changed, so that the video data supplied to the display panel is arranged in the order required by the present disclosure.

In the case of the writing operation, in the prior art, the CPU/display HW inside the game system updates changed portions in the video frame compared to a previous video frame in the display output memory in the “fixed” order.

In the present disclosure, such an update operation is designed to update the important ROI video portion first, not in the “fixed” manner.

Furthermore, in updating the specific ROI video, the order of updating the horizontal lines is the same as the order in which they will be read in the future.

This is because, in the operation of reading the video data of the display output memory, the reading operation is meaningful only when the reading operation is performed after the video data is updated to the latest, and in the operation method of the present disclosure of reading the important data first, when the important data is updated first or the data is not updated in the order in which it will be read in the future, the video data that is read first may be older data that is not the latest.

FIG. 13 illustrates a method of arranging the video data in the order required by the present disclosure when the ROI (e.g., the traffic light in the racing game) is located at the upper end of the video.

In this case, the gate driving circuit is operated in the direction from the upper end to the lower end of the display panel, which is the direction in which the upper end of the display panel is updated early.

An order of application of the video data required by the display panel, according to such operation direction of the gate driving circuit, follows the direction from the upper end to the lower end of the display panel. In the game system, the CPU/display HW first updates the ROI in the display output memory, and in updating the ROI, performs the update in the direction from the upper end to the lower end of the video. In addition, the operation of reading the video data of the display output memory is also performed in the direction from the upper end to the lower end of the screen. The read video data is transmitted to the display system and the display panel, and this is the video data arranged in the order required by the display panel.

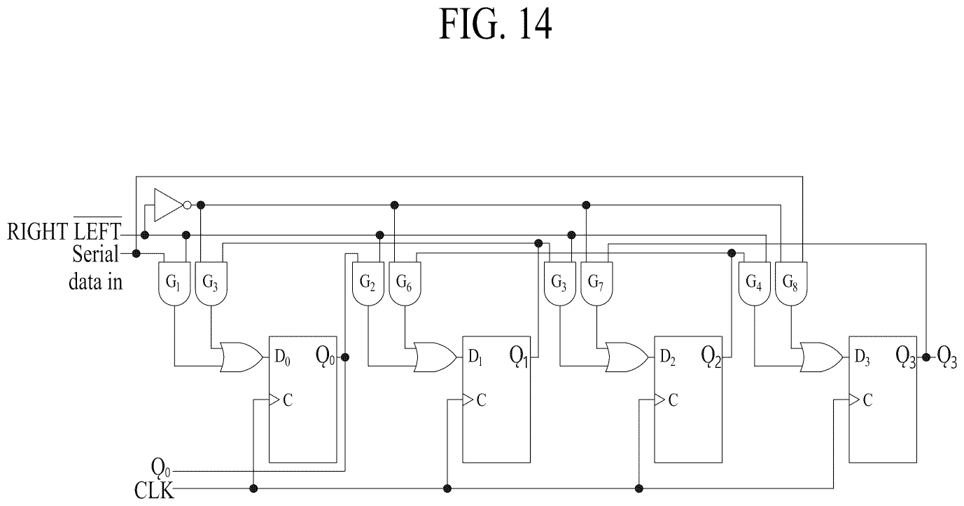

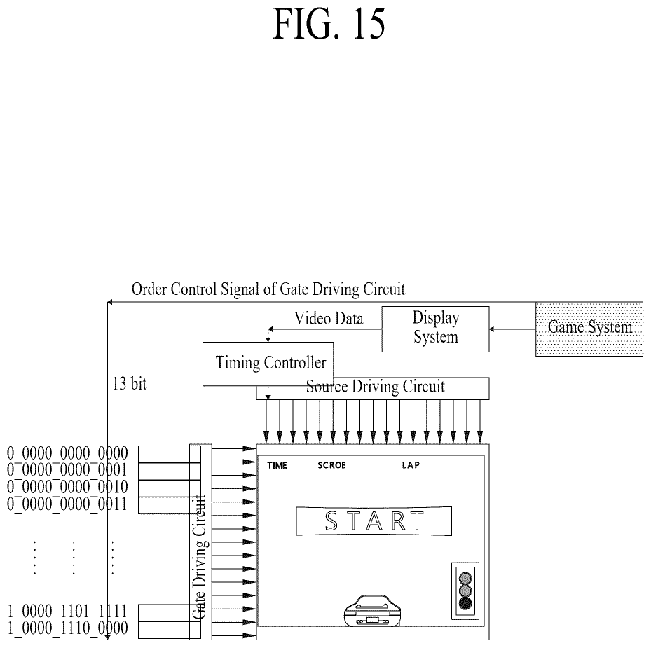

FIG. 14 illustrates a bidirectional shift register according to an embodiment of the present disclosure.

Among the embodiments of the present disclosure described above, to implement the method according to FIG. 6, the gate driving circuit should be able to arbitrarily change the operation direction thereof for each video frame in response to a command of the game system.

To implement this, a shift register constituting the gate driving circuit should be able to operate bidirectionally. To implement the operation direction switching function of the shift register, the bidirectional shift register illustrated in FIG. 14 may be used.

Further, FIG. 15 is a diagram for illustrating the minimum number of bits for controlling a gate driving circuit according to an embodiment of the present disclosure.

To implement the method according to one of FIGS. 7 to 10 among the embodiments of the present disclosure described above, the gate driving circuit should be able to arbitrarily change not only the operation direction but also the operation order thereof for each video frame in response to the command of the game system. An embodiment for implementing this will be described below with reference to FIG. 15.

It is assumed that a maximum resolution of an arbitrary display panel is 8K. The 8K has a vertical resolution of 4320. With the vertical resolution of 4320, control is enabled with 13 bits of information.

For example, each logic that corresponds to each horizontal line of the display panel and controls turning on or off of the horizontal line is assigned a unique number ranging from 0 to (4320-1). Each logic turns on the horizontal line it is in charge of only while receiving a signal of the number assigned thereto, and turns off the horizontal line it is in charge of when the signal is not received. By combining these logics, the gate driving circuit is implemented. Therefore, the game system may control this gate driving circuit with a signal of up to 13 bits.

The present disclosure described above may be implemented with computer-readable codes on a medium in which a program is recorded. Computer-readable media include all kinds of recording devices in which data readable by a computer system is stored. Examples of computer-readable media include a hard disk drive (HDD), a solid state disk (SSD), a silicon disk drive (SDD), a ROM, a RAM, a CD-ROM, a magnetic tape, a floppy disk, an optical data storage device, and the like, and also include those implemented in a form of a carrier wave (e.g., transmission over the Internet). In addition, the computer may include a controller. Accordingly, the above detailed description should not be construed as limiting in all respects and should be considered illustrative. The scope of the present disclosure should be determined by reasonable interpretation of the appended claims, and all changes within the equivalent scope of the present disclosure are included in the scope of the present disclosure.

### Mode

Because the various forms for implementing the invention have been sufficiently described in the best mode above, any redundant description will be omitted.

### INDUSTRIAL APPLICABILITY

The present disclosure is applicable to various display devices and timing controllers (T-Cons), and therefore has industrial applicability.

What is claimed is:

1. A display device comprising:
a gate driving circuit configured to select at least one gate line of a display panel;
a source driving circuit configured to convert video data corresponding to the selected gate line into a video signal, and output the video signal to a source line of the display panel; and
a timing controller configured to determine an operation order of the at least one gate line,
wherein the timing controller is configured to change the operation order of the at least one gate line based on region of interest (ROI) information received from a game system.

2. The display device of claim 1, wherein the timing controller is configured to, when the reception of the ROI information from the game system fails, change the operation order of the at least one gate line based on location information of a mouse pointer.

3. The display device of claim 1, wherein the timing controller is configured to, when the display device corresponds to a TV and operates in a specific mode, control the at least one gate line to operate starting from a center of the display panel.

4. The display device of claim 3, wherein the specific mode corresponds to a game mode where both upper and lower regions of the display panel are processed in black.

5. The display device of claim 1, wherein the game system is located inside or outside the display device.

6. The display device of claim 5, wherein the game system includes both a memory for a reading mode and a memory for a writing mode.

7. The display device of claim 6, wherein video data stored in the memory for the reading mode is read in a specific direction and in a specific order based on ROI information, whereas video data is written in fixed direction and order regardless of ROI information in the memory for the writing mode.

8. The display device of claim 1, wherein when a maximum resolution of the display panel is 8K, at least 13 bits are used to control the gate driving circuit.

9. A timing controller configured to:
receive region of interest (ROI) information from a game system; and
change an operation order of at least one gate line based on the received ROI information.

10. The timing controller of claim 9, wherein the timing controller is configured to:
operate a gate line corresponding to the received ROI information with the highest priority; and
operate a gate line located in a remaining area with a next highest priority.

11. The timing controller of claim 10, wherein the timing controller is configured to, when the reception of the ROI information from the game system fails, change the operation order of the at least one gate line based on location information of a mouse pointer.

12. The timing controller of claim 11, wherein the game system includes both a memory for a reading mode and a memory for a writing mode.

13. The timing controller of claim 12, wherein video data stored in the memory for the reading mode is read in a specific direction and in a specific order based on ROI information, whereas video data is written in fixed direction and order regardless of ROI information in the memory for the writing mode.

14. The timing controller of claim 9, wherein the timing controller is included in a display device.

15. The display device of claim 1, wherein the display panel corresponds to an LED, a mini LED, a micro LED, an OLED, an LCD, or a PDP.
